(19) United States
(12) Patent Application Publication
(10) Pub. No.: US 2022/0083364 A1
(43) Pub. Date: Mar. 17, 2022

(54) RECONCILER SANDBOXES FOR SECURE KUBERNETES OPERATORS

(71) Applicant: SAP SE, Waldorf (DE)

(72) Inventor: Shashank Mohan Jain, Bangalore (IN)

(21) Appl. No.: 17/023,906

(22) Filed: Sep. 17, 2020

(51) Int. Cl. G06F 9/455; G06F 9/50; G06F 21/53

(52) U.S. Cl. CPC G06F 9/45558; G06F 2221/033; G06F 21/53; G06F 9/5027

(57) ABSTRACT

Some embodiments may be associated with a cloud-based computing environment. A computer processor of an orchestration layer platform may deploy and manage multi-tenant workloads (e.g., each being associated with a Virtual Machine (“VM”)) in the cloud-based computing environment. A Kubernetes control plane operator associated with the multi-tenant workloads may detect a trigger event (e.g., an actual VM state not matching a desired VM state) that results in a reconciliation request for a particular tenant workload. Responsive to the reconciliation request, serverless tenant execution code, representing reconciler logic compiled into a Web Assembly (“WASM”) module, may be spun up in a WASM sandbox to perform reconciliation for the particular tenant workload.

### BACKGROUND

An enterprise may utilize applications or services executing in a cloud computing environment. For example, a business might utilize streaming applications that execute at a data center to process purchase orders, human resources tasks, payroll functions, etc. These applications may be executed within Virtual Machines (“VMs”) in the cloud that are deployed and managed by an orchestration layer or scheduler. Kubernetes is an open source orchestration system that implements a control plane operator to ensure that workloads are executing properly (e.g., a reconciler may change a workload from an actual state to a desired state). Consider, for example, a database system such as PostGRE. The operator for deploying the database is tasked to perform multi-tenanted deployment. Although the database itself may be deployed, for example, into its own namespace with proper security privileges from a network and storage point of view, the control plane will still remain a vulnerable attack point because it is deploying and/or reconciling across the multi-tenanted database. If the operator itself is subject to compromise via cyber-attack, this will open up security concerns for all of the tenants.

A goal of an orchestration system and/or operator should be to allow reconciler logic to be run safely in a multi-tenant way. Today, the reconciler may be part of a single Go language binary (although other programming languages might also be used instead). This means that during execution of multi-tenanted control plane operations, the system is violating the norms of isolated execution itself. It would be desirable to provide reconciler sandboxes for operators in a cloud-based computing environment in a secure, automatic, and accurate manner.

### SUMMARY

Methods and systems may be associated with a cloud computing environment. A computer processor of an orchestration layer platform may deploy and manage multi-tenant workloads (e.g., each being associated with a VM) in the cloud-based computing environment. A Kubernetes control plane operator associated with the multi-tenant workloads may detect a trigger event (e.g., an actual VM state not matching a desired VM state) that results in a reconciliation request for a particular tenant workload. Responsive to the reconciliation request, serverless tenant execution code, representing reconciler logic compiled into a Web Assembly (“WASM”) module, may be spun up in a WASM sandbox to perform reconciliation for the particular tenant workload.

Some embodiments comprise: means for deploying and managing, by a computer processor of an orchestration layer platform, multi-tenant workloads in the cloud-based computing environment; means for detecting, by a Kubernetes control plane operator associated with the multi-tenant workloads, a trigger event that results in a reconciliation request for a particular tenant workload; and, responsive to the reconciliation request, means for spinning up serverless tenant execution code, representing reconciler logic compiled into a WASM module, in a WASM sandbox to perform reconciliation for the particular tenant workload.

Some technical advantages of some embodiments disclosed herein are improved systems and methods to provide reconciler sandboxes for operators in a cloud-based computing environment in a secure, automatic, and accurate manner.

### BRIEF DESCRIPTION OF THE DRAWINGS

FIG. 1 is a system in accordance with some embodiments.

FIG. 2 is a method according to some embodiments.

FIG. 3 illustrates a Kubernetes system in accordance with some embodiments.

FIG. 4 is a high-level block diagram of web assembly system in accordance with some embodiments.

FIG. 5 shows a database workload being executed by VMs according to some embodiments.

FIG. 6 shows the provisioning of reconciler logic in accordance with some embodiments.

FIG. 7 is a system architecture display of a web assembly process according to some embodiments.

FIG. 8 is an apparatus or platform according to some embodiments.

FIG. 9 illustrates a web assembly database in accordance with some embodiments.

FIG. 10 illustrates a tablet computer with a web assembly serverless orchestrator display according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Some embodiments described herein provide reconciler sandboxes for operators in a cloud-based computing environment in a secure, automatic, and accurate manner. In particular, some embodiments use a combination of serverless combined with multi-tenanted execution of the control loop itself. This means that each tenant request gets handled by its own reconciler sandbox. The reconciler sandbox may provide following features:
isolation of each tenant request from a memory point of view,
designated Central Processing Unit (“CPU”) cycles should be controllable per request,
isolation of file system via just opening needed file descriptors per request, and
maintenance of code flow integrity.

One way to achieve this would be to launch each tenant reconciler (when an event or watch is triggered) into a separate docker container. This would entail setting up the container and its related requirements such as network needs, filesystem, etc. Another way would be to compile the reconciler logic into WSAM modules. Such an approach may provide substantial flexibility.

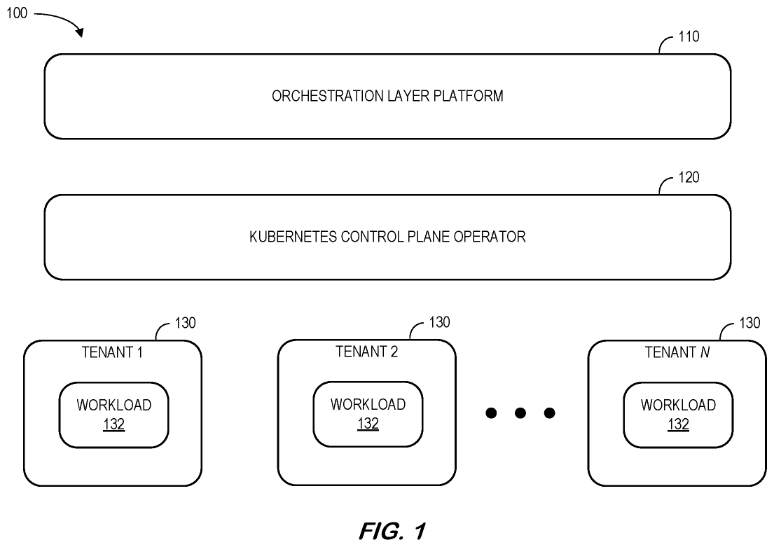

FIG. 1 is a system 100 in accordance with some embodiments. The system includes an orchestration layer platform 110 to deploy and manage multi-tenant workloads (e.g., each being associated with a VM) in a cloud-based computing environment. For example, as illustrated in FIG. 1, tenants 130 1 through N may execute workloads 132. A Kubernetes control plane operator 120 associated with the multi-tenant workloads 132 may detect a trigger event (e.g., an actual VM state not matching a desired VM state) that results in a reconciliation request for a particular tenant workload 132. Responsive to the reconciliation request, serverless tenant execution code, representing reconciler logic compiled into a Web Assembly (“WASM”) module, may be spun up in a WASM sandbox to perform reconciliation for the particular tenant workload 132.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The system 100 may store information into and/or retrieve information from various data stores, which may be locally stored or reside remote from the orchestration layer platform 110 and/or Kubernetes control plane operator 120. Although a single orchestration layer platform 110 and Kubernetes control plane operator 120 are shown in FIG. 1, any number of such devices may be included. Moreover, various devices described herein might be combined according to embodiments of the present invention. For example, in some embodiments, the orchestration layer platform 110 and Kubernetes control plane operator 120 might comprise a single apparatus. The system 100 functions may be performed by a constellation of networked apparatuses, such as in a distributed processing or cloud-based architecture.

A user may access the system 100 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., to implement various rules and policies) and/or provide or receive automatically generated recommendations or results from the system 100.

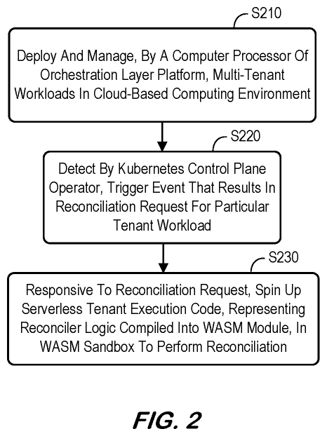

FIG. 2 is a method that might performed by some or all of the elements of any embodiment described herein. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S210, a computer processor of an orchestration layer platform may deploy and/or manage multi-tenant workloads in a cloud-based computing environment. The workloads may be deployed, for example, within VMs that are each assigned an amount of resources (e.g., memory size, Central Processing Unit (“CPU”) utilization, disk space, etc.).

At S220, a Kubernetes control plane operator associated with the multi-tenant workloads may detect a trigger event that results in a reconciliation request for a particular tenant workload. According to some embodiments, the trigger event represents an actual VM state not matching a desired VM state.

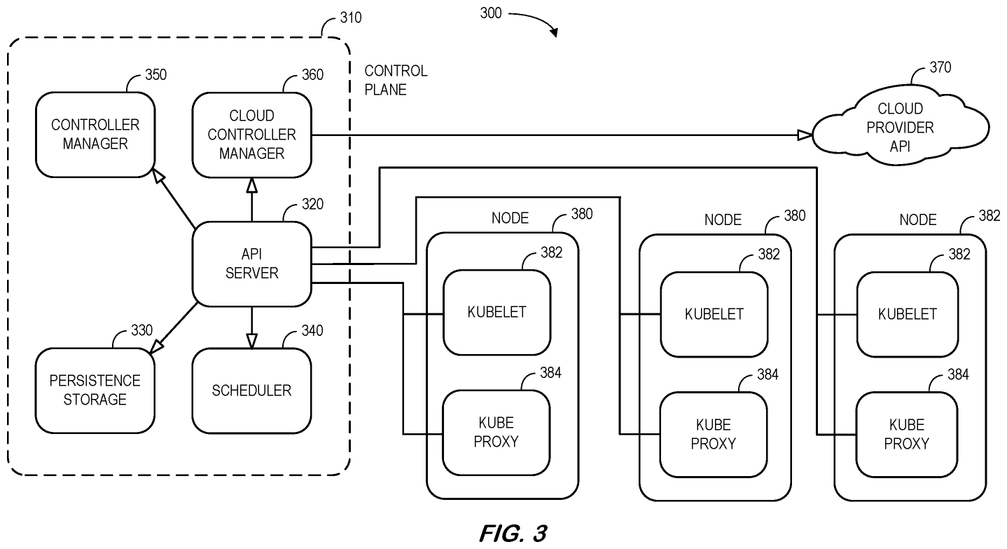

FIG. 3 illustrates a Kubernetes system 300 in accordance with some embodiments. The system 300 represents a “cluster” that includes a control plane 310 and an associated set of machines or nodes 380 that run containerized applications. The nodes 380 host pods that are the components of the application workload. The control plane 310 may run across multiple computers to manage the nodes and the pods in the cluster providing fault-tolerance and high availability.

The components of the control plane 310 components make decisions, such as scheduling decisions and detecting/responding to system 300 events. An Application Programming Interface (“API”) server 320 in the control plane 310 exposes the Kubernetes API at the front end. The control plane also includes persistence storage 330, such as etcd, to provide consistent and highly-available key value store used as a backing store for cluster data. A scheduler 340 may watch for new pods that don't have an assigned node and selects a node for them to run on. A controller manager 350 may run controller processes, such as node controller, replication controller, endpoints controller, etc. In some cases, a cloud controller manager 360 may embed cloud-specific control logic to link the cluster with a cloud provider API 370. Node components 380 may include a Kubelet 382 agent that makes sure containers are running in a pod and a Kube proxy 384 to maintain network rules on nodes (e.g., with network sessions inside or outside of the cluster).

Referring again to FIG. 2, responsive to the reconciliation request, at S230 the system may spin up serverless tenant execution code, representing reconciler logic compiled into a Web Assembly (“WASM”) module, in a WASM sandbox to perform reconciliation for the particular tenant workload. Note that the serverless tenant execution code might not consume resources after the reconciliation is performed for the particular tenant workload.

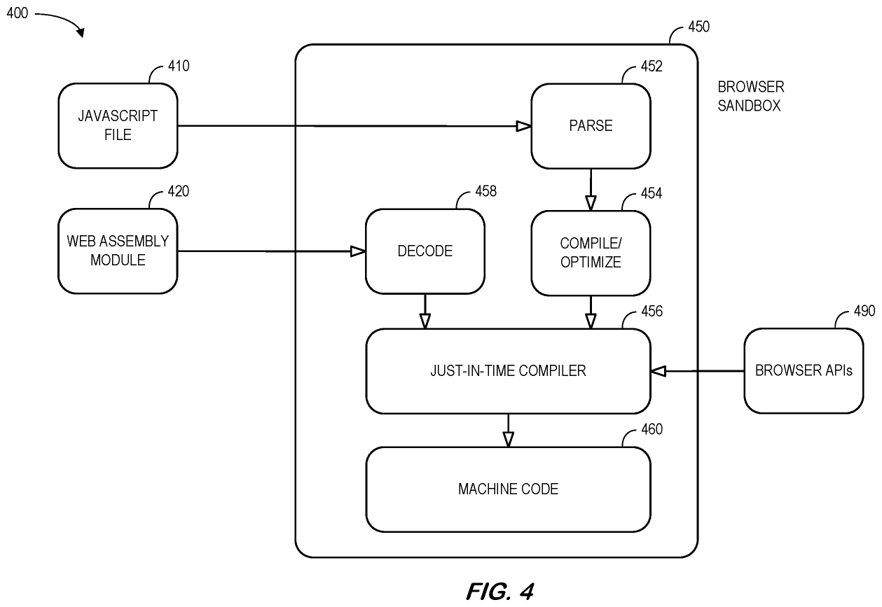

As will now be described, the WASM sandbox may provide memory isolation from other tenants, maintain code flow integrity, execute a tenant control plane, inherit security features by default. FIG. 4 is a high-level block diagram of a WASM system 400 in accordance with some embodiments. In particular, a browser sandbox 450 may execute a JavaScript file 410 and/or a WASM module 420. For a JavaScript file 410, the browser sandbox 450 may utilize a parse element 452 and a compile/optimize element 454 before executing a Just-In-Time (“JIT”) compiler 456 (which may also receive browser Application Programming Interface (“API”) data 490). For a web assembly module 420, the browser sandbox 450 may utilize a decode element 458 before executing the JIT compiler 456. In either case, the output of the JIT compiler may comprise machine code 460. According to some embodiments, the WASM module 420 is a portable binary format designed to be: compact and fast to parse/load so it can be efficiently transferred, loaded, and executed by the browser; compatible with existing web platforms (e.g., to alongside JavaScript, allows calls to/from, access Browser APIs 490, etc.) and run in the same secure sandbox 450 as the JavaScript code 410. Note that higher-level languages can be compiled to a WASM module 420 that is then run by the browser in the same sandboxed environment as the JavaScript code 410. Moreover, WASM modules 420 compiled from higher-level languages may have been already parsed and compiled/optimized so they can go through a fast decoding phase (as the module is already in bytecode format close to machine code) before being injected into the JIT compiler 456. As a result, WASM may represent a more efficient/faster way of running code in a browser, using any higher-level language that can target it for development, while being compatible with existing web technologies.

Cloud computing may demand scalable computing in terms of resource and energy utilization. In some cases, resource utilizations and on-demand provisioning may involve massive data distributions. In serverless computing, developers may need to write functions that execute only when demand comes and keep the resources free at other times. However, existing serverless computing techniques may have limitations in terms of cold-start, a complex architecture for stateful services, problems implementing multi-tenancy, etc. Some embodiments described herein utilize a WASM based runtime that may address some of the existing problems in current serverless architectures. The WASM based runtime may feature resource isolation in terms of CPU, memory, and/or files (and thus offer multi-tenancy within function execution). Further, some embodiments may provide serverless functions that are placed and executed based on data locality and/or gravity (which may help improve execution latency and reduce network usage as compared to existing random function placement strategies).

Traditionally, WASM runtimes were executed within the browser process. Note, however, a WASM runtime can also get executed as a standalone or outside of a browser if the runtimes are accompanied with interfaces that can facilitate system calls. According to some embodiments, the WASM runtimes execute as a separate process which runs a given WASM function using a thread. The WASM runtime process can be provisioned easily with a VM or container (or can even run on a bare machine or a host OS directly).

Compiling reconciler logic into WASM modules may provide sever benefits, such as:
memory isolation,
an ability to control how many CPU cycles a request can take,
maintenance of code flow integrity,
an ability to just open needed File Descriptors (“FDs”) to the WASM module, and
a way to build polyglot (e.g., multi-language) controllers (secure languages can be used to write the reconciler logic and then be compiled into a WASM module.

The WASM module may be invoked per request to reconcile a respective resource. The WASM module may be launched into its own sandbox and consume resources (memory/CPU) only during the period of execution. This means this saves resources in the system because control plane operations are not frequent (and also secures execution against attacks on the operator itself).

Note that one process, such as WasmTime or WASM Secure Capabilities Connector (“WaSCC”), may always run across tenants. The “serverless” part may be the tenant execution code which spins up whenever a reconciliation is needed for a tenant. This may launch a WASM module (a relatively fast process) within the above mentioned WASM runtime (e.g., within a few millisecond).

This also means that everything gets launched within the same process (e.g., WasmTime or WaSCC) which from a resource point of view is the same as running a single operator for multiple tenants. This would still be better if the serverless component made via a full process (e.g., via a side car and launch a docker container which then has more setup in terms of the network and filesystem setup per container). Note that each tenant control plane is executed within the WASM sandbox and inherits the security features by default.

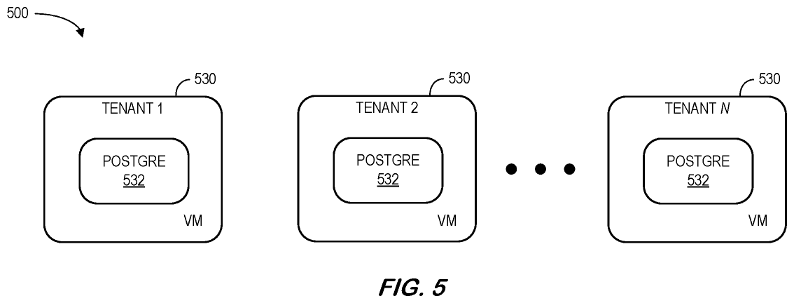

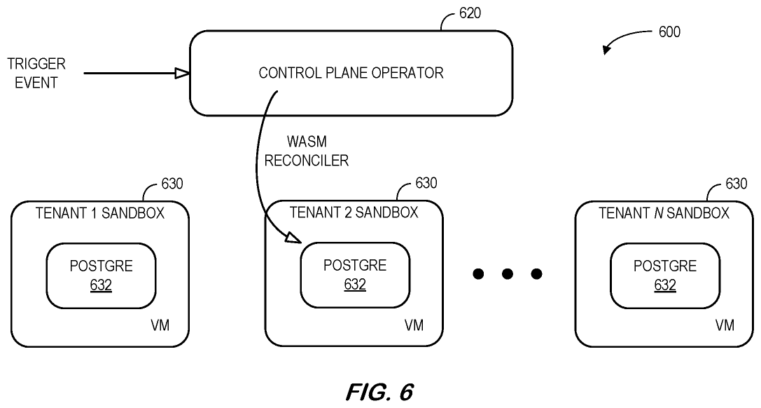

FIG. 5 shows 500 a database workload being executed by VMs according to some embodiments. In particular, each tenant 530 (from 1 through N) is associated with a VM running one or more PostGRE 532 database workloads. FIG. 6 shows 600 the provisioning of reconciler logic in accordance with some embodiments. As before, each tenant sandbox 630 (from 1 through N) is executing a VM running a PostGRE 632 database workload. In this case, a control plane operator 620 detects a trigger event (e.g., that an actual VM state does not match a desired VM state). Responsive to this detection, serverless tenant execution code, representing reconciler logic compiled into a WASM module, is spun up in a WASM sandbox 630 to perform reconciliation for the particular tenant workload 632.

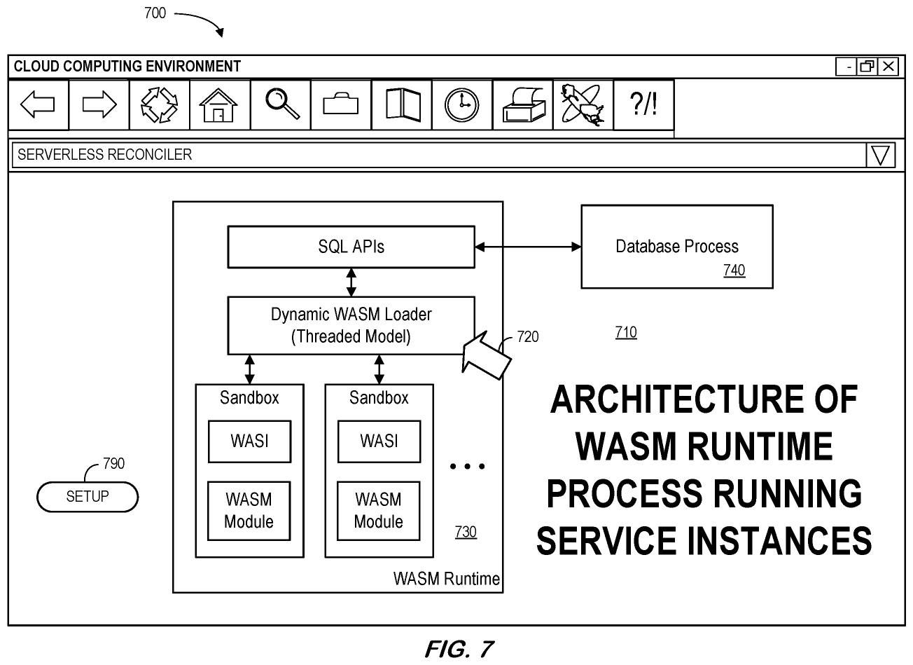

FIG. 7 is a human machine interface display 700 according to some embodiments. The display 700 includes a graphical representation 710 of elements of a cloud-based WASM modules running on a control plane (e.g., the WASM runtime is for control plane operations). Selection of an element (e.g., via a touchscreen or computer pointer 720) may result in display of a pop-up window containing various options (e.g., to adjust rules or logic, assign various machine or devices, etc.). The display 700 may also include a user-selectable “Setup” icon 790 (e.g., to configure parameters for cloud management/provisioning to alter or adjust processes as described with respect any of the embodiments described herein). In some embodiments, a WASM runtime 730 may contain Structured Query Language (“SQL”) APIs that communicate with a database process 740 (e.g., associated with local/remote storage 790). The WASM runtime 730 may also include a dynamic WASM loader (threaded model) to exchange information with local/remote persistence and/or sandboxes (e.g., each having a WASM System Interface (“WASI”) and WASM module).

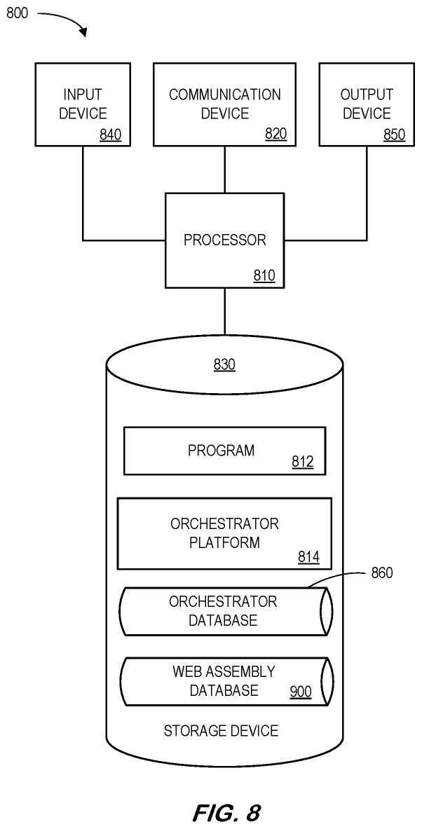

Note that the embodiments described herein may be implemented using any number of different hardware configurations. For example, FIG. 8 is a block diagram of an apparatus or platform 800 that may be, for example, associated with the system 200 of FIG. 2 (and/or any other system described herein). The platform 800 comprises a processor 810, such as one or more commercially available CPUs in the form of one-chip microprocessors, coupled to a communication device 860 configured to communicate via a communication network (not shown in FIG. 8). The communication device 860 may be used to communicate, for example, with one or more remote user platforms, cloud resource providers, etc. The platform 800 further includes an input device 840 (e.g., a computer mouse and/or keyboard to input rules or logic) and/an output device 850 (e.g., a computer monitor to render a display, transmit recommendations, and/or create data center reports). According to some embodiments, a mobile device and/or PC may be used to exchange information with the platform 800.

The processor 810 also communicates with a storage device 830. The storage device 830 can be implemented as a single database or the different components of the storage device 830 can be distributed using multiple databases (that is, different deployment information storage options are possible). The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or orchestrator platform 814 for controlling the processor 810. The processor 810 performs instructions of the programs 812, 814, and thereby operates in accordance with any of the embodiments described herein. For example, the processor 810 may deploy and manage multi-tenant workloads in the cloud-based computing environment. The processor may also facilitate detection, by a Kubernetes control plane operator associated with the multi-tenant workloads, a trigger event that results in a reconciliation request for a particular tenant workload. Responsive to the reconciliation request, the system may spin up serverless tenant execution code, representing reconciler logic compiled into a WASM module, in a WASM sandbox to perform reconciliation for the particular tenant workload.

The programs 812, 814 may be stored in a compressed, uncompiled and/or encrypted format. The programs 812, 814 may furthermore include other program elements, such as an operating system, clipboard application, a database management system, and/or device drivers used by the processor 810 to interface with peripheral devices.

As used herein, information may be “received” by or “transmitted” to, for example: (i) the platform 800 from another device; or (ii) a software application or module within the platform 800 from another software application, module, or any other source.

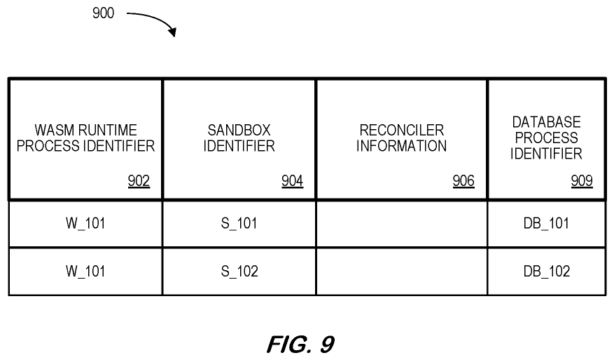

In some embodiments (such as the one shown in FIG. 8), the storage device 830 further stores an orchestrator database 860 and a web assembly database 900. An example of a database that may be used in connection with the platform 800 will now be described in detail with respect to FIG. 9. Note that the database described herein is only one example, and additional and/or different information may be stored therein. Moreover, various databases might be split or combined in accordance with any of the embodiments described herein.

Referring to FIG. 9, a table is shown that represents the web assembly database 900 that may be stored at the platform 800 according to some embodiments. The table may include, for example, entries mapping cloud resources (e.g., for a cloud provider) that may be utilized by applications. The table may also define fields 902, 904, 906, 908, for each of the entries. The fields 902, 904, 906, 908 may, according to some embodiments, specify: a WASM runtime process identifier 902, a sandbox identifier 904, reconciler information 906, and a database process identifier 908. The web assembly database 900 may be created and updated, for example, when a new WASM runtime process is initiated, there are updates to reconciler information, etc. According to some embodiments, the web assembly database 900 may further store details about tenants, security information, mappings, etc.

The WASM runtime process identifier 902 might be a unique alphanumeric label or link that is associated with a particular WASM runtime process being executed on a VM or container. The sandbox identifier 904 might identify a WASM sandbox associated with the runtime (e.g., and as shown in FIG. 9 multiple sandbox identifiers may be associated with a single WASM runtime process identifier “W_101”). The reconciler information 906 might be used to correct a state mismatch, and the database process identifier 908 might identify a process that accesses information in a data store.

Thus, embodiments may provide reconciler sandboxes for operators in a cloud-based computing environment in a secure, automatic, and accurate manner. Moreover, multiple tenants may operate in separate sandboxes (with access to different memories) improving the security of the system. A cloud platform based on Kubernetes with multiple operators that may be used (both in public and private cloud setup), embodiments may save resources by allowing for the serverless execution of reconcilers while securing per tenant reconcile request execution. These benefits may help an enterprise save money as the number of operators increase and also provide indirect benefits associated with a more secure execution environment.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

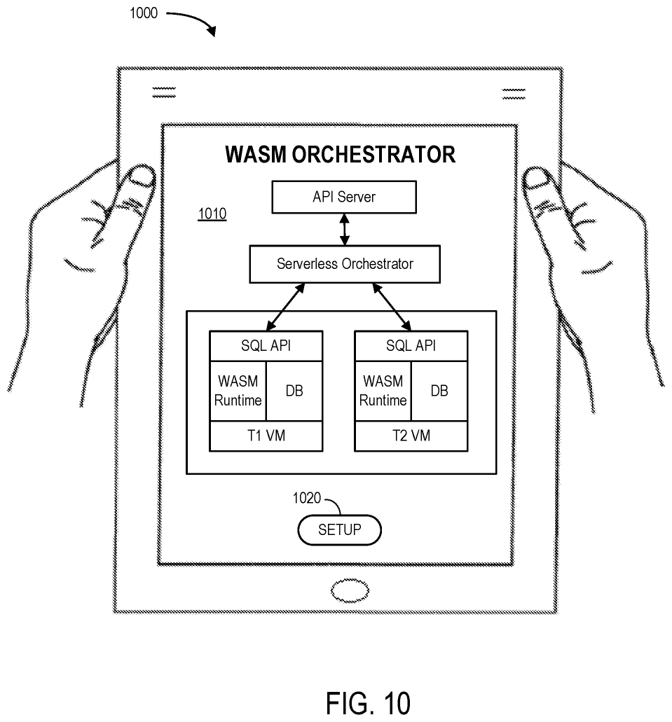

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of applications and services, any of the embodiments described herein could be applied to other types of applications and services. In addition, the displays shown herein are provided only as examples, and any other type of user interface could be implemented. For example, FIG. 10 illustrates a tablet computer 1000 with a WASM serverless orchestrator display 1010 according to some embodiments. The display 1010 may, according to some embodiments, be used to view more detailed elements about components of the system (e.g., when a graphical element is selected via a touchscreen) or to configure operation of the system (e.g., to establish new rules or logic for the system via a “Setup” icon 1020).

FIG. 10 is a system 1000 with a WASM serverless orchestrator deployed on a cloud provisioner in accordance with some embodiments. The serverless orchestrator communicates with API servers and a database deployment associated with a tenant 1 (“T1”) VM and a tenant 2 (“T2”) VM (each having an SQL API, WASM runtime, and database). Note that the serverless orchestrator is not in the data path, instead it takes placement decisions of the PostGRE instances. The operator does a reconciliation job and is also via the API server. All of these are control plane operations. The databases will be accessed directly by the database clients (control plane components such as the API server and operator are not in that path). Each VM has a database process (“DB”) running and a WASM runtime as described with respect to FIG. 7.

According to some embodiments, the WASM based execution runtime offers a sandboxed execution environment. The WASM runtime may, for example, create a continuous memory heap for each sandbox and no pointers from inside the sandbox can access outside memory. To allow system calls for instructions executing inside the sandbox, during compilation of WASM the pointers are detected, and offsets can be passed to interfaces to enable system interactions (e.g., a WASI-WASM system interface). In order to prevent access from outside the WASM sandbox into sandbox heap memory, some embodiments rely on a security enclave such as the Security Guard Extensions (“SGX”) architecture available from INTEL®. Any process running in user-space might get compromised using a root access. As a result, it is possible that the WASM runtime process can get compromised (which can allow data leaks from the WASM heaps or sandboxes). According to some embodiments, a runtime may use an SGX instruction set with native RUST features to create enclaves. Later, the WASM heaps are protected by using SGX instructions and executing the WASM in the enclaves where security is ensured by hardware. Such a system interface may provide protection when WASM functions are executed outside of a browser.

Further, with a threaded model (where each thread executes a WASM function) CPU isolation may be achieved by setting a timer on the thread and then executing a handler to remove the WASM module after the time expires. A proposed runtime, in some embodiments, may achieve filesystem isolation by separating disks and mounting disks for each runtime process. Further, using the principles of capability-based security the runtime may assigns file descriptors (FDs) to WASM functions in a controlled manner.

Additional security features of the WASM runtime might include, according to some embodiments:
separation of execution stack from heap (avoiding buffer overflow attacks);
prohibiting direct references to function pointers to control the instruction pointer and thereby ensuring WASM data integrity;
prohibiting access to system calls by default and exposing only needed file descriptors to the specific WASM module (similar to capability-based security models to reduce an attack surface).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with a cloud-based computing environment, comprising:
an orchestration layer platform, comprising:
a computer processor, and
a memory storage device including instructions that, when executed by the computer processor, enable the orchestration layer platform to:
(i) deploy and manage multi-tenant workloads in the cloud-based computing environment; and
a Kubernetes control plane operator associated with the multi-tenant workloads to detect a trigger event that results in a reconciliation request for a particular tenant workload,
wherein, responsive to the reconciliation request, serverless tenant execution code, representing reconciler logic compiled into a Web Assembly (“WASM”) module, is spun up in a WASM sandbox to perform reconciliation for the particular tenant workload.

2. The system of claim 1, wherein the workloads are deployed within Virtual Machines (“VM”).

3. The system of claim 2, wherein each VM is assigned an amount of resources.

4. The system of claim 3, wherein the resources are associated with at least one of: (i) memory size, (ii) Central Processing Unit (“CPU”) utilization, and (iii) disk space.

5. The system of claim 1, wherein the trigger event represents an actual VM state not matching a desired VM state.

6. The system of claim 1, wherein the serverless tenant execution code does not consume resources after the reconciliation is performed for the particular tenant workload.

7. The system of claim 1, wherein the WASM sandbox provides memory isolation from other tenants.

8. The system of claim 1, wherein the WASM sandbox maintains code flow integrity.

9. The system of claim 1, wherein the WASM sandbox executes a tenant control plane and inherits security features by default.

10. A computer-implemented method associated with a cloud-based computing environment, comprising:
deploying and managing, by a computer processor of an orchestration layer platform, multi-tenant workloads in the cloud-based computing environment;
detecting, by a Kubernetes control plane operator associated with the multi-tenant workloads, a trigger event that results in a reconciliation request for a particular tenant workload; and
responsive to the reconciliation request, spinning up serverless tenant execution code, representing reconciler logic compiled into a Web Assembly (“WASM”) module, in a WASM sandbox to perform reconciliation for the particular tenant workload.

11. The method of claim 10, wherein the workloads are deployed within Virtual Machines (“VM”).

12. The method of claim 11, wherein each VM is assigned an amount of resources.

13. The method of claim 12, wherein the resources are associated with at least one of: (i) memory size, (ii) Central Processing Unit (“CPU”) utilization, and (iii) disk space.

14. The method of claim 10, wherein the trigger event represents an actual VM state not matching a desired VM state.

15. The method of claim 10, wherein the serverless tenant execution code does not consume resources after the reconciliation is performed for the particular tenant workload.

16. The method of claim 10, wherein the WASM sandbox provides memory isolation from other tenants.

17. The method of claim 10, wherein the WASM sandbox maintains code flow integrity.

18. The method of claim 10, wherein the WASM sandbox executes a tenant control plane and inherits security features by default.

19. A non-transitory, computer readable medium having executable instructions stored therein that, when executed by a computer processor cause the processor to perform a method associated with a cloud-based computing environment, the method comprising:
deploying and managing, by a computer processor of an orchestration layer platform, multi-tenant workloads in the cloud-based computing environment;
detecting, by a Kubernetes control plane operator associated with the multi-tenant workloads, a trigger event that results in a reconciliation request for a particular tenant workload; and
responsive to the reconciliation request, spinning up serverless tenant execution code, representing reconciler logic compiled into a Web Assembly (“WASM”) module, in a WASM sandbox to perform reconciliation for the particular tenant workload.

20. The medium of claim 19, wherein the workloads are deployed within Virtual Machines (“VM”) and the trigger event represents an actual VM state not matching a desired VM state.

21. The medium of claim 19, wherein the serverless tenant execution code does not consume resources after the reconciliation is performed for the particular tenant workload.
